(19) United States
(12) Patent Application Publication
(10) Pub. No.: US 2012/0213572 A1
(43) Pub. Date: Aug. 23, 2012

(54) Device For Temporarily Holding An Object

(76) Inventors: David Mischnick, Berlin (DE); Oliver Preradovic, Berlin (DE); Florian Buehs, Berlin (DE); Detlev Schnee, Berlin (DE)

(21) Appl. No.: 13/402,466

(22) Filed: Feb. 22, 2012

(30) Foreign Application Priority Data
Feb. 22, 2011 (DE) 10 2011 012 419.5

(51) Int. Cl. F16B 2/02

(52) U.S. Cl. 403/5

(57) ABSTRACT

A device for temporarily holding an object having a three dimensional outer contour comprises at least two clamping elements between which said object can be brought. At least one clamping element is being movable towards the other clamping element. At least one of said movable clamping elements is designed as an expandable elastic body. A fluid can be supplied to said expandable elastic body for expanding the same. The expandable elastic body is being able to nestle against the outer contour of the object and to adapt to said contour. The control system controls a supply of said fluid to said expandable elastic body, said control system being able to control an expansion and a collapsing of said body.

### BACKGROUND OF THE INVENTION

The invention relates to a device for temporarily holding an object having a three dimensional outer contour, in particular a medical instrument.

Many objects, in particular medical instruments, have an elongate body, which in most cases has a relatively long, thin shaft and, at the proximal end, a handpiece or headpiece with a greater diameter than the shaft. Such objects have a three dimensional outer contour.

There is a need for such objects, in particular medical instruments, to be held temporarily in a defined position or orientation by means of a device. In the case of an endoscopic instrument, visual observation can be performed through the instrument, either by the naked eye or by means of a camera, which transmits an image onto a monitor.

In minimally invasive surgery, which is practiced widely, such an instrument is inserted into a body cavity and is targeted at a precisely defined location in the body, for example an ulcer that is to be removed.

To do this, the operator first introduces the endoscope into the body and then orients the endoscope until he has found the precise location that is to be observed. The endoscopic instrument is then intended to remain exactly in this position, for example such that an image coming from a camera and showing the operating site can be viewed permanently on a monitor.

For this procedure, the operator then has to use other instruments, with the result that he cannot hold the endoscopic viewing instrument in a defined orientation.

The devices mentioned at the outset for temporarily holding such an object are provided for this purpose.

In principle, these devices are designed such that at least two clamping elements are present that lie opposite each other, wherein at least one of the two clamping elements is movable. During handling, the movable clamping element is moved away from the other clamping element to such an extent that the object can be brought into place between them. The at least one clamping element is then moved such that it bears on the object that is to be held and presses this object against the other clamping element, such that the object is then finally held between the two clamping elements.

The movement of the movable clamping element is obtained by means of a knurled screw. The two clamping elements are produced from rigid or stiff materials. Since objects of the kind that are to be held often have a round outer profile, particularly in the area of a shaft or stem, at least one clamping element in most cases has notch-like indents in order to create a multi-point bearing of the clamping elements about a circular outer contour of this kind. This is intended to avoid a situation where the clamping elements merely engage diametrically opposite each other on the outer face, with the danger that movable clamping elements are not sufficiently tightened and rolling movements cause the object to move.

Particularly in the aforementioned field of use of an endoscopic instrument, the position of the instrument that is held temporarily by the device should as far as possible not alter, since even very slight changes of position could mean that the targeted site is no longer visible. In the case of very long and slim elements, attachment to a relatively thin shaft is associated with the danger of tilting movements, particularly if relatively bulky and heavy component groups are present at one end of the object. In the case of an endoscope, several laterally protruding connection pieces, for example for the delivery and removal of gaseous or liquid media, are often located on the proximal handle part or head part, and these connection pieces have a considerable weight and, particularly in the case of an oblique position of the object that is to be held, cause a considerable tilting moment.

It is therefore desirable for an object of this kind to be held directly at the larger and also in most cases heavy structural part, that is to say at the proximal headpiece or handpiece.

If an instrument is held by way of a shaft with a circular cross section, the variability exists only in the diameter, such that a relatively wide range of different instrument sizes can be held by way of the shaft using a single device.

If objects are intended to be held by way of a handle part with another geometry or with alternating geometries and with very different sizes, clamping between these known clamping elements is possible only with difficulty and cannot be achieved with sufficient safety.

Moreover, the handling procedure is very awkward in principle, since very finely threaded knurled screws often have to be turned several times during the clamping, in order to move the clamping elements towards each other.

It has therefore become customary for a manufacturer to offer a device specifically adapted for holding the object produced by said manufacturer.

However, this would mean that, for example in an operating theatre in which numerous instruments from different manufacturers are used, a correspondingly large number of different devices for temporarily holding the object would then also have to be kept in stock.

This is undesirable and expensive and would unnecessarily clutter the storage space in an operating theatre.

The problem addressed by the present invention is therefore to remedy this situation and to develop a device of the type mentioned at the outset for temporarily holding an object, such that a large number of differently shaped objects can be held safely and in a very defined orientation using a single device. Moreover, the fixing procedure should be able to be performed as simply and as quickly as possible.

### SUMMARY OF THE INVENTION

According to the invention, the problem is solved by a device for temporarily holding an object having a three dimensional outer contour, comprising at least two clamping elements between which an object having a three dimensional outer contour can be brought, at least one clamping element being movable towards another clamping element, thereby holding said object between said movable clamping element and said other clamping element, wherein at least said movable clamping element being designed as an expandable elastic body, a fluid can be supplied to said expandable elastic body for expanding the same, said expandable elastic body, when expanded, being able to nestle against said three dimensional outer contour of said object and to adapt to said three dimensional outer contour of said object thereby holding said object fixedly, and a control system for controlling a supply of said fluid to said expandable elastic body, said control system being able to control an expansion and a collapsing of said body.

These measures have numerous advantages.

By providing a clamping element in the form of an expandable elastic body, the latter can be moved by expansion towards the objects that are to be clamped or held and can press these objects against the other clamping element. By virtue of the elasticity, the body nestles around areas of the outer face of the object to be held and thus adapts to the outer contour thereof. This opens up the possibility of a wide range of objects of different size and different geometry being held in the device. The fluid that expands the elastic body ensures the sufficient contact pressure.

Taking the example of a handpiece with differently shaped gripping grooves in which fingers can be placed, the elastic body can adapt to this contour, i.e. can extend into the finger grooves, such that a relatively large-surface, form-fit engagement is obtained between the elastic body and the outer face of the object that is to be held.

The fluid, which can be gaseous, e.g. compressed air, or liquid, for example water or an oil, ensures the sufficient force for pressing the object against the other clamping element and at the same time for conforming the elastic body to the outer contour of the object that is to be held.

Handling is therefore particularly simple, since the object simply has to be placed between the two clamping elements, and the at least one expandable clamping element is then expanded by the fluid. This is done via the control system. There is therefore no longer a need to carry out handling measures such as repeatedly turning an adjusting screw or the like. The same applies of course for the release of the object from the device, in which case the pressure applied by the fluid merely has to be cancelled, such that the elastic body then collapses, after which the object can easily be removed from the device.

By virtue of the relatively large-surface contact of the elastic body on the outer face of the object that is to be held, a relatively low pressing force is already sufficient to hold the object in a very defined spatial orientation.

This relatively low contact pressure also opens up the possibility that, if so desired, the object can be moved in the device. For example, if an object is held by way of a long shaft with a circular cross section, it is possible to turn the object in the device or, if appropriate, to move the object to and fro axially along the shaft, in which case it maintains its basic geometric orientation. This is advantageous, for example, when using endoscopes that have a viewing direction deviating from the central longitudinal axis of the shaft. By turning the shaft in the device, it is then additionally possible to see areas around the operating site. By axial movement, it is possible to obtain focussing or to observe a smaller or larger viewing field of the operating site, without thereby changing the basic spatial orientation of the object.

It is to be regarded as a particular advantage that the device not only allows an object to be held very easily and very safely, but also permits certain movements that are expedient and desired.

In another embodiment of the invention, the body is designed as a hollow body, of which the interior can be supplied with the fluid.

This measure has the advantage that the expansion procedure can very easily be performed safely and in a targeted manner.

In the collapsed state, the fluid is removed from the interior of the hollow body, such that the object can be pushed into the device or removed therefrom. By introducing the fluid into this hollow body, the latter is expanded and moved in a targeted manner towards the other clamping element, either by a displacement or by inflation of the entire hollow body.

The fluid now acts on the interior of the hollow body such that no contaminants can enter this adjustment mechanism. In the case of a fine-pitch thread in the devices of the type mentioned at the outset, the thread turns represent bacterial niches, which can be cleaned only with great difficulty and at some cost.

It is also common in the medical field to provide such appliances with a drape during a surgical intervention, for example to cover it or wrap it with a plastic film. In the device of the type mentioned at the outset with the moved adjustment screws, there is the danger of such a drape being damaged by the adjustment screw and of contaminants getting in through the protective drape.

Since flexible films of this kind likewise constitute flexible bodies, they can be used without problem in connection with the device according to the invention. In other words, the clamping elements can be covered with such a drape, since these films are able to follow the expansion movement of the body, without any danger of tears or the like occurring.

Both the device and also the object to be held can be provided with such a drape, since the expandable body places both a film that surrounds the expandable body itself, and also a film that surrounds the object to be held, firmly on the respective body or clamping element. This is to be regarded as a considerable advantage of the device in the medical field.

In another embodiment of the invention, the expandable elastic body is designed as a cushion, which is held and/or guided on a seat in a frame.

This measure has the advantage that the cushion can be secured firmly on the seat and can then be moved or inflated accordingly by the fluid. By means of the frame, the cushion moves in a targeted manner towards the opposite clamping element when supplied with fluid.

This further facilitates the simple handling of the device, particularly also the insertion of the object with the cushion not expanded.

In another embodiment of the invention, both clamping elements are designed as expandable elastic bodies.

This measure has the considerable advantage that the object is held particularly firmly and securely, since elastically expandable bodies bear on the object from both sides. In this embodiment, care does not have to be taken to ensure that the object is already placed in a defined orientation on a stationary clamping element in order to exclude the possibility that, upon the approach of the movable clamping element, the position or orientation on the stationary element is changed by turning or tilting.

The object simply has to be brought between the two clamping elements, and the expanding elastic bodies then conform to it from both sides.

In this way, for example, objects that have a relatively thin shaft can be held in a very stable position, and the possibility mentioned at the outset of turning the shaft or moving it axially is still afforded.

In another embodiment of the invention, the two expandable elastic bodies are secured on opposite seats arranged at a distance from each other.

This measure has the considerable advantage that the seats themselves can be made very stable and stationary. In this way, it is also possible to do without hinge-like connections with pivot pins which, particularly in the medical field, constitute problematic niches for bacteria. The seats also represent a counter-abutment against the contact pressure.

The distance between the two expandable bodies, or between the corresponding seats, can then be chosen such that a very wide range of different sizes of objects to be held can be brought between the seats. By corresponding expansion of the elastic bodies, the object is then held between them. In the case of a bulky object with a relatively large diameter, the bodies then have to be expanded only across a relatively small path, and correspondingly further in the case of slimmer or thinner devices. This clearly demonstrates the variable range of use of a single device for objects of different sizes and of different geometric shapes.

In another embodiment of the invention, the expandable elastic body of a clamping element is made up of several individual expandable elastic bodies.

This measure has the advantage that these individual expandable elastic bodies permit an even better adaptation to particularly contoured objects. In the case of a single body, and with an extremely contoured or very narrow object, lateral bulges could arise, which do not serve for holding purposes. By means of the division into several individual bodies, such deviation is more limited.

In another embodiment of the invention, each of the several individual expandable elastic bodies can be supplied, independently of another, with the fluid via the control system.

This measure has the advantage of permitting a particularly finely adjusted and individual adaptation to different geometries of objects to be held, since each expandable body can be controlled individually.

In another embodiment of the invention, the device has a U-shaped main body, and the two clamping elements are mounted on opposite inner faces of the arms of the U.

This permits a compact and robust design of the device. The open face of the U clearly shows the user the direction in which he is intended to introduce or fit the object.

In another embodiment of the invention, a slip prevention means is present, which blocks a slipping movement of an object from the device when the clamping element is not expanded.

This measure has the advantage that the object does not slip from the device in the event of a defect or a failure of the fluid supply. In the case of sensitive objects, it is thus possible to prevent these from falling to the floor and being damaged after slipping.

In another embodiment of the invention, the slip prevention means on the U-shaped body has a lower plate, as seen in the direction of gravity, which lower plate has an opening through which shaft-like components of an object extend, while components of greater diameter can be held back.

This measure has the advantage of providing particularly simple mechanical securing against objects dropping in the direction of gravity. This opens up the possibility that objects with a relatively bulky body at one end, for example a handle, can be held in this area, while the rest of the body extends from the device through the opening.

In another embodiment of the invention, the opening is designed as a slit opening to the open face of the U of the main body.

This measure has the advantage that the object can be pushed into the slit of the device from the direction of the open face of the U, this being done in such a way that a bulky body, for example a handle, is brought between the clamping elements, while an elongate shaft or stem can protrude from the device through the slit or the slit opening, particularly downwards, as seen in the direction of gravity. This likewise facilitates handling and ensures a secure hold even with the elastic bodies not expanded.

In another embodiment, the arms of the main body are closed by a wall.

This wall constitutes an additional supporting or bearing surface, such that an object held in the device bears at three points or is held by component parts of the device. These are, in the first instance, the two opposite engagement sites of the expanded elements and, moreover, the wall that extends transversely thereto and connects an end of the arms of the U.

In another embodiment of the invention, all the expandable elastic bodies which can be supplied with the fluid are connected via lines to a single source of the fluid.

This measure has the advantage that only a single source or a single storage vessel has to be made available for the fluid. This also opens up the possibility that all the expandable bodies that can be supplied with the fluid can be allowed to communicate with one another via these lines.

This opens up the possibility, for example, that by partial collapse of a body on one side by removal of fluid, and by simultaneous delivery and further expansion of an opposite body, the position of a body held in the device can be changed. In this way, for example, fine orientations and fine adjustments can be made, for example by means of an object held between the bodies being offset laterally or tilted, or both movements being superposed. The device thus not only serves purely as a holder, but at the same time, albeit only to a certain extent, also as an orienting device for the object.

In another embodiment of the invention, provision is made that, by means of the control system, each of the elastic bodies can be supplied, independently of another, with the fluid via valves.

In this way, each individual elastic expandable body can be supplied very specifically with corresponding amounts of fluid, or these can be removed from it, in order to perform the aforementioned fine adjustments.

In another embodiment of the invention, the control system has a control element via which all the expandable bodies are collapsible at the same time.

This measure has the considerable advantage, in terms of handling, that all the bodies can be relieved or collapsed simultaneously via this single control element, such that an object can be removed very easily and quickly from the device.

It will be appreciated that the aforementioned features and the features still to be explained below can be used not only in the cited combinations but also in other combinations or singly, without departing from the scope of the present invention.

### BRIEF DESCRIPTION OF THE DRAWINGS

The invention is described and explained in more detail on the basis of a number of selected illustrative embodiments and with reference to the attached drawings, in which:

FIG. 1 shows a perspective view of a first illustrative embodiment of a device according to the invention, with the elastic body not yet expanded,

FIG. 2 shows a corresponding view with an expanded elastic body, which functions as a movable clamping element,

FIG. 3 shows a slightly simplified perspective view of another illustrative embodiment, with two mutually opposite clamping elements in the form of expandable elastic bodies, the figure depicting how an object that is to be held by the device is intended to be introduced into the latter,

FIG. 4 shows the view of the second illustrative embodiment in which the object is held by the expanded elastic bodies,

FIG. 5 shows a plan view of the depiction in FIG. 4,

FIG. 6 shows a view of a third illustrative embodiment of a device according to the invention, in which the expandable bodies of a clamping element are divided into three individual bodies,

FIG. 7 shows a fourth illustrative embodiment of a device according to the invention, with still further division into a multiplicity of expandable bodies,

FIG. 8 shows a fifth illustrative embodiment of a device according to the invention, partially in cross section, depicting how a shaft of an object is held in a basic position between two clamping elements, wherein each clamping element has two expandable elastic bodies,

FIG. 9 shows a view comparable to FIG. 8, depicting how the shaft from FIG. 8 is laterally offset within the device, and

FIG. 10shows a corresponding view depicting how the shaft held in the device can also be tilted.

### DETAILED DESCRIPTION OF PREFERRED EMBODIMENTS

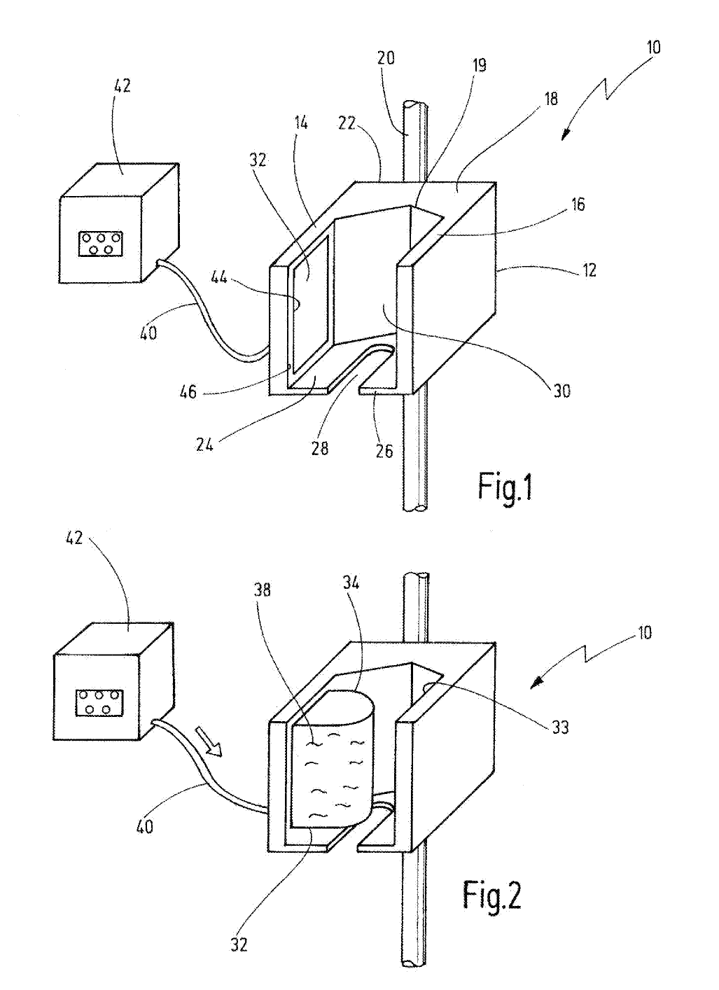

A first illustrative embodiment of a device according to the invention, shown in FIGS. 1 and 2, is designated in its entirety by reference number 10.

The device 10 has a solid U-shaped main body 12. Two plate-shaped arms 14 and 16 of the main body 12, arranged at a distance from each other and running parallel to each other, extend from a wall 18 that connects them at one end.

The inner face of the wall 18 is provided with a notch 19.

A stanchion 20, on which the main body 12 is secured, is mounted on the outer or rear face 22 of the wall 18. If the device is designed to be transportable, the stanchion 20 is designed such that it can be placed on a floor surface and the main body 12 can be locked on the stanchion 20 at a defined height. However, the main body 12 can also be secured on a telescopic arm or the like, which can be secured anywhere on a wall or somewhere else. It can be seen from FIGS. 1 and 2 that the main body 12 is arranged such that the open face of the U is directed towards the observer.

A slip prevention means 24 is arranged on what is, in the direction of gravity, a lower end of the arms 14 and 16.

The slip prevention means 24 consists of a lower base plate 26, which connects the two arms 14 and 16 and is provided more or less centrally with a slit 28.

The slit 28 in the base plate 26 opens to the side 30 of the main body 12 directed towards the observer. A clamping element 32 is mounted on the inner face 46 of the arm 14. The clamping element 32 is constructed as an elastic, closed hollow body 34, which is mounted in a recess (not shown in detail here) in the arm 14 and bonded on one side. The hollow body 34 is designed as a kind of cushion 44.

A fluid 38, which is either a gaseous fluid, for example compressed air, or a liquid, can be introduced from a control system 42 into the interior 36 of the cushion 44, as is indicated by an arrow in FIG. 2.

The cushion 44 expands in this way, as is shown in FIG. 2, i.e. it moves in the direction of the opposite arm 16, which here functions as a stationary, second clamping element 33.

If an object (not shown here) is located between the inner face of the arm 16, acting as stationary clamping element 33, and the expanding cushion 44, this object is clamped between the two arms 14 and 16 and is held in the device 10.

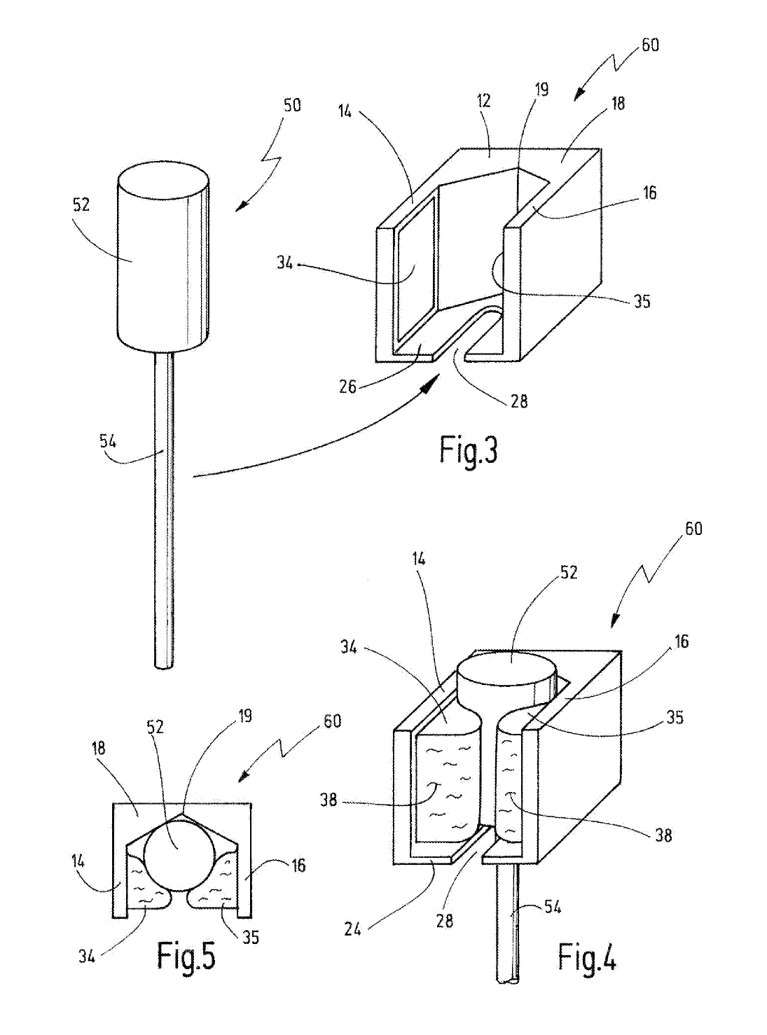

With reference to FIGS. 3 to 5, this procedure is described and explained in more detail in connection with a second illustrative embodiment of a device 60 according to the invention.

The device 60 shown in FIG. 3 has basically the same design as the device in FIGS. 1 and 2, although the stanchion 20 and the control system 42 have been omitted to provide better clarity. Therefore, in FIGS. 3 to 5, the same reference signs have also been used for what are basically identical components.

In other words, the device 60 also has a U-shaped main body 12, which has two parallel arms 14 and 16. Here, clamping elements in the form of elastic expandable hollow bodies 34 and 35 are mounted on the inner face of the arms 14 and 16, respectively, as has already been described in connection with FIG. 1. Of course, both hollow bodies 34 and 35 are connected to the control system via lines, such that both hollow bodies 34 and 35 can be supplied with a fluid and expanded.

FIG. 3 shows how an object 50 is intended to be introduced into the device 60.

The object 50 is intended to symbolize a body with a relatively large, bulky head 52 at one end and, extending away from this head 52, an elongate shaft 54 of smaller diameter.

This object stands symbolically for a medical endoscopic instrument, for example.

As will be seen from FIG. 3, the object 50 can be inserted laterally, for example, into the device 60, such that the shaft 54 is inserted into the open slit 28.

It is also possible to insert the object 50 from above into the main body 12 between the arms 14 and 16.

The object 50 is expediently fitted into the device 60 in such a way that it comes to lie on the rear wall 18 provided with the notch 19, as can be seen in particular from FIG. 5.

It is expedient, but not absolutely essential, for the lower end of the head 52 of greater diameter to be deposited on the base plate 26 of the slip prevention means.

When the hollow bodies 34 and 35 are activated, i.e. when fluid 38 is supplied to them, the elastic hollow bodies 34 and 35 expand and bear against the outer face of the head 52 of the object 50. The hollow bodies 34 and 35 adapt to the three dimensional outer contour of the object 50. It will be seen from the plan view in FIG. 5 that the head 52 is held by the two mutually opposite inflated or expanded hollow bodies 34 and 35 and also by the wall 18.

If the object 50 has this circular geometry, it is obvious that the object 50 can, for example, be turned about its longitudinal axis even in the fixed state. It is also possible, if so desired, to lift the object 50 slightly in the direction of its shaft axis, if so desired.

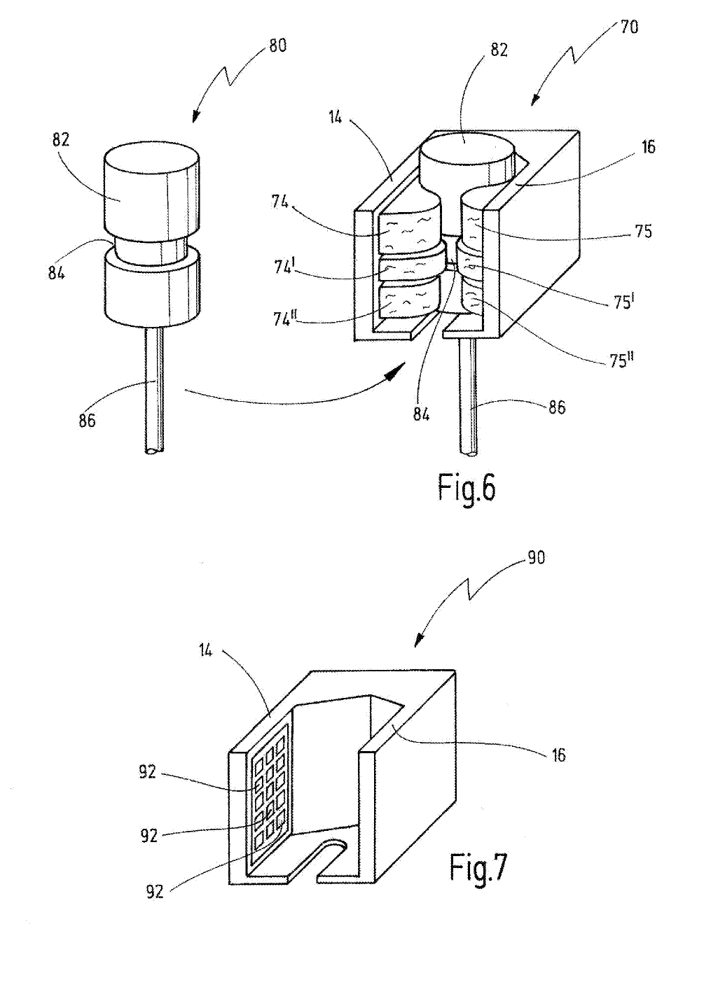

In the third illustrative embodiment of a device 70 according to the invention, shown in FIG. 6, the device is once again of the same design as the previously described illustrative embodiments, as far as the main body and the arms 14 and 16 are concerned. In the device 70 also, expandable hollow bodies are arranged as clamping elements on the inner faces of both arms 14 and 16.

Three hollow bodies 74, 74′ and 74″, arranged above one another and separate from one another, are arranged on the inner face of the arm 14. Lying exactly opposite them, three hollow bodies 75, 75′ and 75″, separate from one another, are arranged correspondingly on the inner face of the arm 16. Each of the individual hollow bodies 74, 74′, 74″ and 75, 75′, 75″ is connected via a separate supply line to the control system (not shown here), i.e. each one of the hollow bodies can be supplied individually with a fluid.

By way of explanation, FIG. 6 shows an object 80, of which the large, bulky head has a narrowed throat 84. Here too, a shaft 86 extends away from the head 82.

When this object 80 is pushed into the device 70 and the hollow bodies are inflated, the middle one of the hollow bodies, namely 74′ and 75′, can extend slightly farther into the object, specifically into the narrowed throat 84, for example. This demonstrates the flexible and finely adaptable adjustment of the flexible hollow bodies for achieving an effective hold of an object 80.

FIG. 7 shows a fourth illustrative embodiment of a device 90 according to the invention, which device is also once again basically of the same design as the devices described previously, but with a multiplicity of elastic, expandable hollow bodies 92 arranged here in a pattern on one or both faces of the arms 14 and 16.

In the illustrative embodiment shown in FIG. 7, there are three such bodies lying next to one another at one height, and, moreover, five such bodies lying above one another.

This is of course just one selected illustrative embodiment, and it can be accordingly varied. Depending on their size and design, all of the hollow bodies can be controlled and filled with fluid individually, or it is also possible for individual groups or several groups to be controlled, depending on what is required. This allows a proper adaption to different shaped outer contours of the objects to be held.

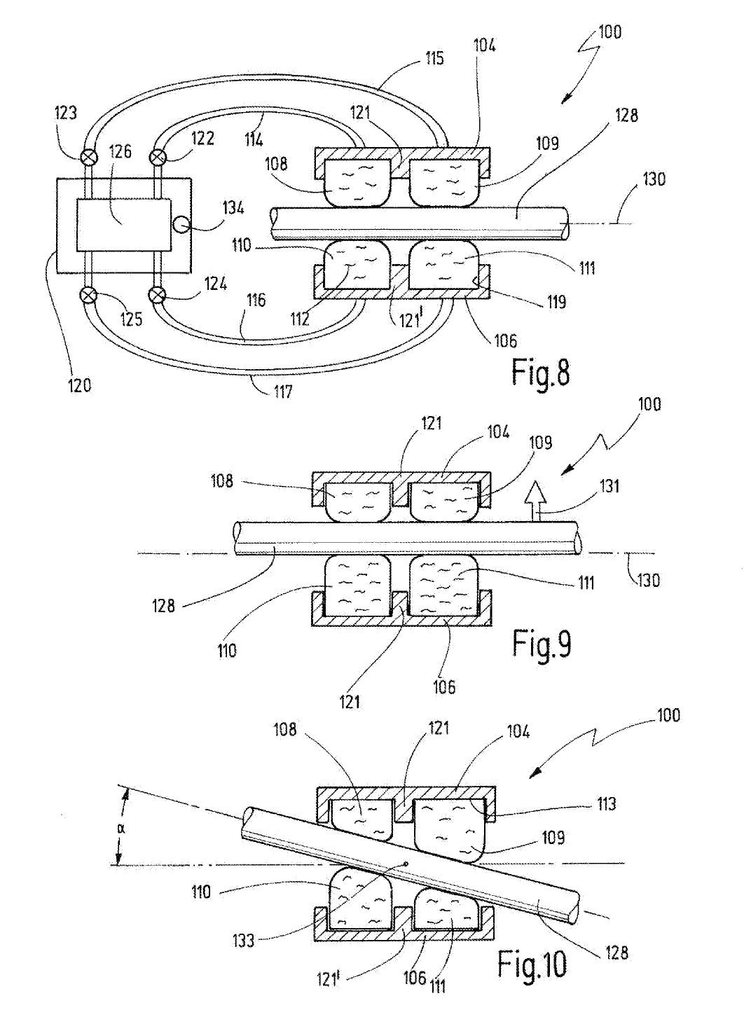

FIGS. 8 to 10 show another configuration in the context of a fifth illustrative embodiment of a device 100 according to the invention.

It will be seen from the sectional view in FIG. 8 that two arms 104 and 106 are once again present here, which extend parallel to each other and at a distance from each other.

Two elastically deformable clamping elements, which are designed as cushions 108 and 109, are formed on the inner face of the arm 104. Two cushions 110, 111 are correspondingly mounted on the opposite arm 106. For this purpose, the arm 104 has, on its inner face, a corresponding seat 113, and a corresponding seat 119 is present on the arm 106. Each seat has a frame 121, 121′, in which the corresponding cushion is held and guided. Each of the cushions 108, 109, 110, 111 is connected to a control system 120 via a separate line 114, 115, 116, 117. A valve 122-125 is also arranged in the path of each line 114-117, which valves can all be controlled individually and independently of one another.

All the lines 114-117 are fed with a fluid 112, in this case a liquid, from a common storage vessel 126.

FIG. 8 shows a state in which all four cushions 108-111 are supplied equally with the fluid 112. In this way, the shaft 128 is held centrally in a starting position 130. Although this is a horizontal position in the view in FIG. 8, it can of course also be a correspondingly vertical or obliquely oriented position.

FIG. 9 shows that the two cushions 108 and 109 have collapsed slightly, whereas the cushions 110, 111 are further expanded or inflated.

This has happened by virtue of the fact that, in accordance with the view in FIG. 8, a certain amount of fluid 112 in liquid form, specifically in each case the same amount, has been removed from the cushions 108, 109 via the lines 114, 115 by the control system 120, and specifically removed to the common storage vessel 126. At the same time, a correspondingly larger amount of fluid 112 has been forced into the cushions 110, 111 by the control system 120 via the lines 116, 117.

In this way, as can be seen from the change from FIG. 8 to FIG. 9, the shaft 128 has moved from its starting position 130, and it has specifically moved upwards in this view, as is indicated by an arrow 131.

It will be clear from this that an object held in the device 100 can be moved to a certain extent, but as such is held securely.

FIG. 10 shows how the shaft 128 has moved from its starting position 130 by a tilting movement.

To this end, some fluid was removed from the cushion 108, and slightly more fluid was delivered to the cushion 109.

Accordingly, fluid was correspondingly delivered to the cushion 110 lying opposite the cushion 108, and fluid was correspondingly removed from the cushion 111. This leads to a turning or tilting of the shaft 128 about a rotation point 133.

It is reasonable that both movements can also be combined, i.e. that the shaft 128 is lifted or lowered from its starting position 130 or, in the case of a vertical orientation, is offset to the left or right, and at the same time a pivoting movement is executed.

This is made possible by the fact that each cushion 108-111 can be controlled individually via the corresponding lines 114-117, i.e. can be supplied with additional fluid and thus expanded, or by the fact that fluid is removed from the corresponding cushion and the latter correspondingly collapses.

With the object held securely in the device 100, this still allows the person handling the device to make certain changes to the orientation or position of the object. Therefore, instead of the device simply performing a purely holding function, it can also to some extent serve as an orienting or positioning device.

FIG. 8 shows that the control system 120 has a control element 134. By actuation of the control element 134, all four cushions 108-111 can be relieved simultaneously and thus collapse, such that the clamping action can be cancelled by a single actuation, and the object, say the shaft 128, can be removed from the device 100. By virtue of the fact that all the cushions are supplied from a single storage container, a closed liquid system is present, and there is therefore no danger of contaminants being able to get into the fluid if the device is used in the medical field.

As was explained in the introduction, it is possible to cover the device and also the object, i.e. the shaft 128, with a drape, without thereby adversely affecting the function of the holding device.

If the fluid is a gaseous fluid, compressed air is normally used, which either originates from a compressed-air container or is made available in situ by a compressor in the control system.

What is claimed is:

1. A device for temporarily holding an object having a three dimensional outer contour, comprising:
at least two clamping elements between which an object having a three dimensional outer contour can be brought,
at least one clamping element being movable towards another clamping element, thereby holding said object between said movable clamping element and said other clamping element, wherein
at least said movable clamping element being designed as an expandable elastic body,
a fluid can be supplied to said expandable elastic body for expanding the same, said expandable elastic body, when expanded, being able to nestle against said three dimensional outer contour of said object and to adapt to said three dimensional outer contour of said object thereby holding said object fixedly, and
a control system for controlling a supply of said fluid to said expandable elastic body, said control system being able to control an expansion and a collapsing of said body.

2. The device of claim 1, wherein said expandable elastic body is designed as a hollow body, an interior of said hollow body can be supplied with said fluid.

3. The device of claim 1, wherein said expandable body is designed as a cushion, said cushion being held on a seat on a frame supporting said expandable body.

4. The device of claim 1, wherein said at least one expandable clamping element and at least said other clamping element are designed as expandable elastic bodies.

5. The device of claim 4, wherein said at least one expandable clamping element and said at least one other clamping element are arranged on opposite sides in a seat of a frame, said expandable elastic bodies are arranged at a distance from one another.

6. The device of claim 1, wherein each expandable elastic body is made up of several individual expandable elastic bodies.

7. The device of claim 6, wherein each of said several individual expandable elastic bodies can be supplied, independently of another, with said fluid via said control system.

8. The device of claim 1, having a U-shaped main body, said at least two clamping elements are mounted on opposite inner faces of arms of said U-shaped main body.

9. The device of claim 1, wherein a slip preventing means is present, which blocks a slipping movement of an object away from said device when said at least one movable clamping element is not yet expanded.

10. The device of claim 8, wherein said U-shaped main body is provided with a slip prevention means, which blocks a slipping movement of said object from said device when said at least one movable clamping element is not yet expanded, said slip prevention means having a lower plate, as seen in a direction of gravity, said lower blade having an opening through which a shaft-like component of an object can extend, while components of greater diameter are held back by said lower plate.

11. The device of claim 10, wherein said opening being designed as a slit opening to an open face of a “U” of said U-shaped main body.

12. The device of claim 11, wherein arms of said U of said main body are connected by a wall.

13. The device of claim 7, wherein said control system has a single source of said fluid, said single source being connected via lines to all of said several expandable elastic bodies.

14. The device of claim 13, wherein said control system being designed in that each of said expandable elastic bodies can be supplied, independently of another, with said fluid via valves.

15. The device of claim 14, wherein said control system has a control element via which all of said expanded bodies are collapsible at the same time.
